(19) United States
(12) Patent Application Publication
(10) Pub. No.: US 2017/0053149 A1
(43) Pub. Date: Feb. 23, 2017

(54) METHOD AND APPARATUS FOR FINGERPRINT IDENTIFICATION

(71) Applicant: Xiaomi Inc., Beijing (CN)

(72) Inventors: Zhongsheng JIANG, Beijing (CN); Jun TAO, Beijing (CN); Dan LIU, Beijing (CN)

(73) Assignee: Xiaomi Inc., Beijing (CN)

(21) Appl. No.: 15/177,465

(22) Filed: Jun. 9, 2016

(30) Foreign Application Priority Data
Aug. 21, 2015 (CN) 201510520041.8

(51) Int. Cl. G06K 9/00; G06F 3/0482; G06F 21/32; G06F 3/0484

(52) U.S. Cl. CPC G06K 9/0002; G06K 9/00067; G06K 9/0008; G06F 3/04847; G06F 3/0482; G06K 9/00087; G06F 21/32

(57) ABSTRACT

A method for fingerprint identification includes acquiring a fingerprint image and extracting feature information of the fingerprint image, obtaining current operation information and obtaining a feature threshold corresponding to a security level of fingerprint identification based on the current operation information, and comparing the feature information with verification feature information stored in advance. Fingerprint identification succeeds if the comparison satisfies a comparison threshold and the fingerprint identification fails if the comparison fails to satisfy the comparison threshold.

### PRIORITY STATEMENT

This application is based on and claims priority to Chinese Patent Application 201510520041.8, filed on Aug. 21, 2015, the entire contents of which are incorporated herein by reference.

### TECHNICAL FIELD

The present disclosure relates to fields of communication technology, and more particularly, to a method and an apparatus for fingerprint identification.

### BACKGROUND

With rapid development of technology related to mobile terminals, various mobile terminals such as mobile phones have become widely used with increasing functions. Novel functions bring convenience to daily life and thus are well enjoyed by users. For example, a mobile phone may provide with a virtual button for fingerprint identification, by touching which a user may perform the fingerprint identification for completing an unlock operation.

A typical virtual button for fingerprint identification is implemented by providing a fingerprint identification sensor under a glass cover. When a user touches the glass cover with a finger, a signal may be recognized by the fingerprint identification sensor for further fingerprint identification.

However, because the fingerprint identification sensor is provided under the glass cover, sensitivity of the fingerprint identification sensor may be reduced, and thus a rate of successful fingerprint identification may be low.

### SUMMARY

The present disclosure relates to methods and apparatuses for fingerprint identification according to the present disclosure.

According to an aspect of the present disclosure, an electronic device may comprises a processor-readable storage medium comprising a set of instructions for image identification; and a processor in communication with the storage medium. When executing the set of instructions, the processor is directed to: obtain a target image for authorization of a target event though image identification; obtain a target security requirement associated with the target event from a plurality of levels of security requirements; determine whether the target image is successfully identified based on the target security requirement; and operate the target event when the target image is successfully identified.

According to another aspect of the present disclosure, a method for image identification may comprise: obtaining, by a mobile terminal, a target image for authorization of a target event though image identification; obtaining, by the mobile terminal, a target security requirement associated with the target event from a plurality of levels of security requirements; determining, by the mobile terminal, whether the target image is successfully identified based on the target security requirement; and operating, by the mobile terminal, the target event when the target image is successfully identified.

According to yet another aspect of the present disclosure, a processor-readable non-transitory storage medium may comprise a set of instruction for image identification. When executed by a processor the set of instruction directs the processor to perform actions of: obtaining a target image for authorization of a target event though image identification; obtaining a target security requirement associated with the target event from a plurality of levels of security requirements; determining whether the target image is successfully identified based on the target security requirement; and operating the target event when the target image is successfully identified.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flowchart illustrating a method for fingerprint identification according to an exemplary embodiment.

FIG. 2 is a flowchart illustrating a process for obtaining feature threshold according to an exemplary embodiment.

FIG. 3 is a flowchart illustrating another process for obtaining feature threshold according to an exemplary embodiment.

FIG. 4a is a first block diagram illustrating an interface of a mobile terminal according to an exemplary embodiment.

FIG. 4b is a second block diagram illustrating an interface of a mobile terminal according to an exemplary embodiment.

FIG. 5 is a flowchart illustrating yet another process for obtaining feature threshold according to an exemplary embodiment.

FIG. 6 is a flowchart illustrating still another process for obtaining feature threshold according to an exemplary embodiment.

FIG. 7a is a third block diagram illustrating an interface of a mobile terminal according to an exemplary embodiment.

FIG. 7b is a fourth block diagram illustrating an interface of a mobile terminal according to an exemplary embodiment.

FIGS. 8a-8c are schematic diagrams illustrating a scenario that a method for fingerprint identification applies according to an exemplary embodiment.

FIG. 9 is a block diagram illustrating an apparatus for fingerprint identification according to an exemplary embodiment.

FIG. 10 is a block diagram illustrating another apparatus for fingerprint identification according to an exemplary embodiment.

FIG. 11 is a block diagram illustrating another apparatus for fingerprint identification according to an exemplary embodiment.

FIG. 12 is a block diagram illustrating another apparatus for fingerprint identification according to an exemplary embodiment.

FIG. 13 is a block diagram illustrating another apparatus for fingerprint identification according to an exemplary embodiment.

FIG. 14 is a block diagram illustrating a device suitable for fingerprint identification according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

FIG. 14 is a block diagram illustrating a device applicable for fingerprint identification according to an exemplary embodiment. For example, the device 1400 may be a mobile phone, a computer, a digital broadcast terminal, a messaging device, a gaming console, a tablet device, a medical device, an exercise equipment, a personal digital assistant, an aircraft, and the like.

Referring to FIG. 14, the device 1400 may include one or more of the following components: a processing component 1402, a memory 1404, a power component 1406, a multimedia component 1408, an audio component 1410, an input/output (I/O) interface 1412, a sensor component 1414, and a communication component 1416.

The processing component 1402 typically controls overall operations of the device 1400, such as the operations associated with display, telephone calls, data communications, camera operations, and recording operations. The processing component 1402 may include one or more processors 1420 to execute instructions to perform all or part of the steps in the above described methods. Moreover, the processing component 1402 may include one or more modules which facilitate the interaction between the processing component 1402 and other components. For instance, the processing component 1402 may include a multimedia module to facilitate the interaction between the multimedia component 1408 and the processing component 1402.

The memory 1404 may be configured to store various types of data to support the operation of the device 1400. Examples of such data include instructions for any applications or methods operated on the device 1400, contact data, phonebook data, messages, pictures, video, etc. The memory 1404 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1406 provides power to various components of the device 1400. The power component 1406 may include a power management system, one or more power sources, and any other components associated with the generation, management, and distribution of power in the device 1400.

The multimedia component 1408 may include a screen providing an output interface between the device 1400 and the user. In some embodiments, the screen may include a liquid crystal display (LCD) and a touch panel (TP). If the screen may include the touch panel, the screen may be implemented as a touch screen to receive input signals from the user. The touch panel may include one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1408 may include a front camera and/or a rear camera. The front camera and the rear camera may receive an external multimedia datum while the device 1400 is in an operation mode, such as a photographing mode or a video mode. Each of the front camera and the rear camera may be a fixed optical lens system or have focus and optical zoom capability.

The audio component 1410 may be configured to output and/or input audio signals. For example, the audio component 1410 may include a microphone (“MIC”) configured to receive an external audio signal when the device 1400 is in an operation mode, such as a call mode, a recording mode, and a voice recognition mode. The received audio signal may be further stored in the memory 1404 or transmitted via the communication component 1416. In some embodiments, the audio component 1410 further may include a speaker to output audio signals.

The I/O interface 1412 provides an interface between the processing component 1402 and peripheral interface modules, such as a keyboard, a click wheel, buttons, and the like. The buttons may include, but are not limited to, a home button, a volume button, a starting button, and a locking button.

The sensor component 1414 may include one or more sensors to support a plurality of status evaluations of the apparatus 1400. For example, the sensor component 1414 may include a fingerprint identification sensor, which locates under a fingerprint identification area on the screen of the multimedia component 1408. For example, the fingerprint sensor may be a capacity sensor to sense a capacity between the sensor and a fingertip; the fingerprint sensor may also be an ultrasonic sensor or optical sensor to obtain a surface profile or an image of the fingertip. When the mobile terminal detects a user's fingerprint, the mobile terminal may activate the fingerprint identification sensor and display a virtual key for fingerprint recognition on the fingerprint recognition area. The virtual key may be an icon to identify the fingerprint identification area so that the user knows where to place his/her finger on. When the user touches the virtual key, the fingerprint identification sensor may collect the fingerprint information from the fingerprint identification area. Further, the mobile terminal may also include a fingerprint identification integrate circuit, which is connected to the sensor to receive signals detected thereby.

The sensor component 1414 may also include one or more sensors to provide status assessments of various other aspects of the device 1400. For instance, the sensor component 1414 may detect an open/closed status of the device 1400, relative positioning of components, e.g., the display and the keypad, of the device 1400, a change in position of the device 1400 or a component of the device 1400, a presence or absence of user contact with the device 1400, an orientation or an acceleration/deceleration of the device 1400, and a change in temperature of the device 1400. The sensor component 1414 may include a proximity sensor configured to detect the presence of nearby objects without any physical contact. The sensor component 1414 may also include a light sensor, such as a CMOS or CCD image sensor, for use in imaging applications. In some embodiments, the sensor component 1414 may also include an accelerometer sensor, a gyroscope sensor, a magnetic sensor, a pressure sensor, or a temperature sensor.

The communication component 1416 may be configured to facilitate communication, wired or wirelessly, between the device 1400 and other devices. The device 1400 may access a wireless network based on a communication standard, such as WiFi, 2G, or 3G, or a combination thereof. In one exemplary embodiment, the communication component 1416 receives a broadcast signal or broadcast associated information from an external broadcast management system via a broadcast channel. In one exemplary embodiment, the communication component 1416 further may include a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1400 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer readable storage medium including instructions, such as included in the memory 1404, executable by the processor 1420 in the device 1400, for performing the above-described methods. For example, the non-transitory computer-readable storage medium may be a ROM, a RAM, a CD-ROM, a magnetic tape, a floppy disc, an optical data storage device, and the like.

FIG. 1 is a flowchart illustrating a method for fingerprint identification according to an exemplary embodiment. The method for fingerprint identification may be implemented in a mobile terminal such as the apparatus 1000 in FIG. 10. For example, the method may be implemented as an application or a set of instructions stored in the non-transitory storage medium of the mobile terminal. A processor of the mobile terminal may communicate with the storage medium and execute the set of instructions to perform steps in the method. The method may include the following steps S101-S103.

In step S101, a fingerprint image is obtained and feature information of the fingerprint image is extracted.

In one embodiment, the mobile terminal may include a fingerprint identification sensor beneath an area of the screen of the mobile terminal. The fingerprint recognition sensor may be a capacity sensor, ultrasonic sensor, and/or optical sensor to sensor the ridges and valleys of one's fingerprint. The mobile terminal may display a virtual button on the screen above the sensor. When a user touches with a finger on the mobile terminal, for example, on the virtual button for fingerprint identification of a mobile phone, the mobile terminal (e.g., the processor of the mobile terminal) may direct the sensor to scan the finger of the user and obtain a fingerprint image of the user. The fingerprint image may be pre-processed by a fingerprint identification circuit of the mobile terminal, such that the feature information of the fingerprint image may be extracted from the preprocessed fingerprint image.

In step S102, current mobile terminal operation information is obtained, and a feature threshold corresponding to a security level of fingerprint identification is obtained based on the current mobile terminal operation information.

The current mobile terminal operation information may be information of a target event that the mobile terminal may operate but need authorization in advance. For example, the mobile terminal may need identifying the user when someone is trying to login the mobile terminal, conducting an online payment, changing certain system settings, or calling an application installed in the mobile terminal. For illustration purpose, the present disclosure takes calling an application and an operation to the operation system of the mobile terminal as an example. In an embodiment, the current mobile terminal operation information may include an application program identifier or current system environment information, for example, information indicative of whether an operation system of the mobile phone is currently in a state of screen lock.

Different target events may have different security requirements to confirm the user identify. For example, if the target event is calling an application, the need to make sure that the instruction to run the application is from the owner of the mobile terminal may be mild. However, if someone is trying to use the mobile terminal to make an online payment, the need to confirm that the instruction comes from the owner of the mobile terminal may be very high. Therefore, the mobile system may need to identify the security requirement when receiving an instruction to operate a target event, and then identify the source of the instruction according to the security requirement before operation of the target event. In the present disclosure, the user's identity is recognized through fingerprint identification. Thus the mobile terminal may initiate the target event only when the fingerprint identification under the required level of security is successful.

In the embodiment, the current mobile terminal operation information may be obtained by the fingerprint identification circuit. For example, the fingerprint identification circuit may obtain an identifier of an application program that is currently running. The application identifier may correspond with a security level for fingerprint identification. Each security level may further correspond with a feature threshold. For example, the higher the security level of a fingerprint identification operation, the larger the value of the feature threshold. Accordingly, the fingerprint identification circuit and/or the mobile terminal may obtain a feature threshold corresponds to the security level based on the application identifier. In another example, the fingerprint identification circuit may obtain the current system environment information. The system environment information may correspond with a certain security level of fingerprint identification, which may further correspond with a feature threshold. Accordingly, the fingerprint identification circuit and/or mobile terminal may obtain the feature threshold based on the current system environment information.

In an embodiment, different mobile terminal operation information may correspond to different security levels of fingerprint identification, while different security levels of fingerprint identification may correspond to different feature thresholds.

For example, a security level of fingerprint identification for awaking and unlocking screen may correspond to a first level, while a security level of fingerprint identification for payment with fingerprint may correspond to a fourth level, where the first level is weaker than the fourth level, i.e., the first level requires a lower level of security than the fourth level. The security level may be a number reflecting a probability that the extracted feature information matches the pre-stored verification feature information, such as a percentage of information matching between extracted feature information and pre-stored verification feature information. For example, a feature threshold corresponding to the first level may be 0.6, while a feature threshold corresponding to the fourth level may be 1.

It should be noted that, the security levels of fingerprint identification and the feature thresholds thereof are described as above for purpose of exemplary illustration instead of being limited by the embodiments of the present disclosure.

Moreover, there is no limitation applied on the order for performing the steps S101 and S102 described above.

In step S103, the extracted feature information is compared with pre-stored verification feature information; it is determined that the fingerprint identification succeeds if a comparison result reaches the feature threshold, and that the fingerprint identification fails if the comparison result does not reach the feature threshold. For those fingerprint image who meets the feature threshold, the mobile terminal may determine that the identification of the user who scanned the fingerprint meets the security requirement.

In the embodiment, the verification feature information may be used for verifying whether the fingerprint information scanned and input to the mobile terminal is valid. The verification information may be stored in the mobile terminal prior to the fingerprint identification. Before conducting the fingerprint identification, the user may operate the mobile terminal to scan his/her fingerprint and thereby input a reference fingerprint image into the mobile terminal. The mobile terminal may analyze the image and extract therefrom reference features. Then the mobile terminal may store the reference features as verification features for future varication use. Later, when a user scan his/her finger again, the mobile terminal may obtain the user's fingerprint image and extract therefrom the feature information of the fingerprint image. The mobile terminal may compare the extracted fingerprint feature information with the pre-stored verification feature and obtain and/or determine a similarity score of the two. Meanwhile, depending on the current mobile terminal operation information (e.g., the system environment or application identifier), the mobile terminal may determine the security level of the current mobile terminal operation and then determine and/or obtain the corresponding feature threshold. With the feature threshold, the mobile terminal may determine whether the fingerprint image passes the verification. The fingerprint identification succeeds if the similarity is greater than the feature threshold; and the fingerprint identification fails if the similarity is less than the feature threshold.

Assuming that, there are 5 features included in the pre-stored verification feature information, and the security level of fingerprint identification for the current application program is at the first level, corresponding to a feature threshold of 0.6. For example, the features may correspond to a shape of a grove, a ridge furcation, etc. at particular position of a fingerprint image. The mobile terminal may assign a value to each features and put the 5 features together to form a vector, e.g., V={feature1, feature2, feature3, feature4, feature5}. Accordingly, the pre-stored verification features may be formed as a reference vector V0, whereas the extracted features of a fingerprint image may be represented by a target vector V1. To compare the similarity between the extracted features and the pre-stored verification features, the mobile terminal may compare the similarity between V0 and V1. Thus, in comparison between the extracted feature information and the verification feature information, it may be determined the fingerprint identification succeeds if there are matches for three of the features, that is, the comparison result reaches the corresponding feature threshold. Otherwise, it may be determined the fingerprint identification fails if there are matches for only two of the features, that is, the comparison result does not reach the corresponding feature threshold.

According to the embodiments of the method for fingerprint identification described above, the current mobile terminal operation information is obtained and the feature threshold corresponding to the security level of fingerprint identification is obtained based thereon, the fingerprint identification is then performed according to the extracted feature information and the corresponding feature threshold, thus a process of fingerprint identification may be finished based on the feature threshold corresponding to the security level of fingerprint identification, thereby improving a rate of successful fingerprint identification.

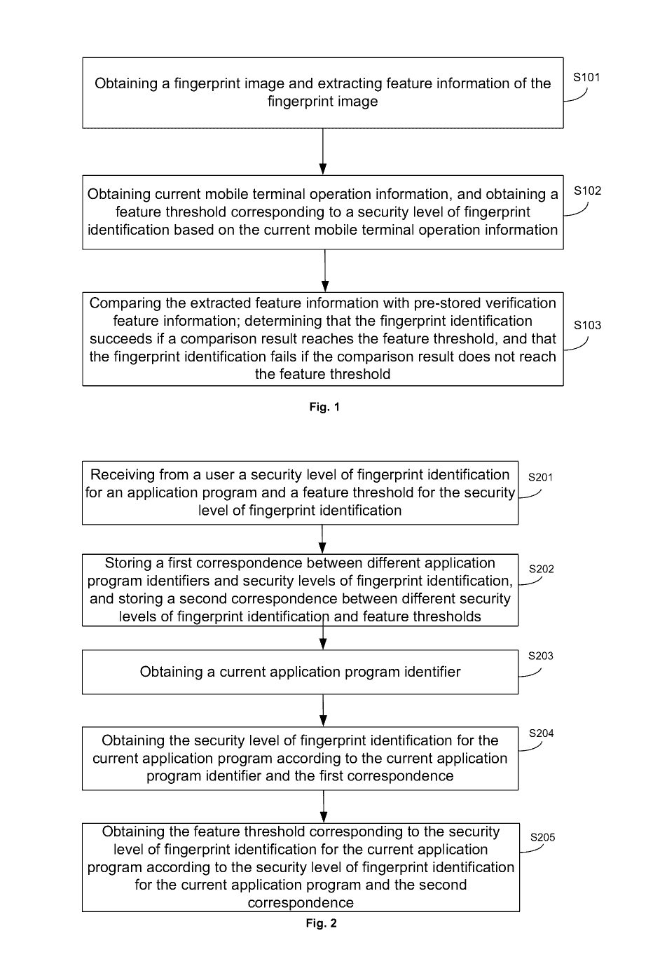

FIG. 2 is a flowchart illustrating a process for obtaining feature threshold according to an exemplary embodiment. The method for fingerprint identification may be implemented in a mobile terminal such as the apparatus 1000 in FIG. 10. For example, the method may be implemented as an application or a set of instructions stored in the non-transitory storage medium of the mobile terminal. A processor of the mobile terminal may communicate with the storage medium and execute the set of instructions to perform steps in the method. The method may include the following steps S201-S205.

In step S201, receiving from a user a security level of fingerprint identification for an application program and a feature threshold for the security level of fingerprint identification.

In order to improve the success rate of fingerprint identification, the mobile terminal may provide an interface to allow the user to set the security level of fingerprint identification to each of a plurality of different mobile terminal operations (i.e., running application programs installed in the mobile terminal or system operations of the mobile terminal). Accordingly, the mobile terminal may also provide an interface to allow the user to set the feature threshold to each of the plurality of mobile terminal operation.

For example, user may set, through a first interface displayed on the screen of the mobile terminal, that application programs A-D correspond to the first level, application programs E and G correspond to the second level, and an application program G corresponds to the third level. Furthermore, the user may further go to a second interface (or in the same interface) to set that a feature threshold of the first level is 0.6, that of the second level is 0.8, and that of the third level is 0.9.

In step S202, storing a first correspondence between different application program identifiers and security levels of fingerprint identification, and storing a second correspondence between different security levels of fingerprint identification and feature thresholds.

In the embodiment, after the security levels of fingerprint identification for different application programs and the feature thresholds for different security levels of fingerprint identification are already set, the mobile terminal may store the first correspondence between different application program identifiers and the security levels of fingerprint identification, as well as the second correspondence between different security levels of fingerprint identification and the feature thresholds. This information may be stored in a local storage medium of the mobile terminal or may be store in an account of the user in CLOUD or a remote server in communication with the mobile terminal.

In step S203, obtaining a current application program identifier.

In the embodiment, the current application program identifier may be obtained by the fingerprint identification IC (Integrated Circuit) circuit of the mobile terminal.

In step S204, obtaining the security level of fingerprint identification for the current application program according to the current application program identifier and the first correspondence.

In the embodiment, the security level of fingerprint identification for the current application program may be obtained according to the obtained current application program identifier and the stored first correspondence.

In step S205, obtaining the feature threshold corresponding to the security level of fingerprint identification for the current application program according to the security level of fingerprint identification for the current application program and the second correspondence.

In the embodiment, the feature threshold corresponding to the security level of fingerprint identification for the current application program may be obtained according to the obtained security level of fingerprint identification and the stored second correspondence.

According to the embodiment described above, the first correspondence between different application program identifiers and the security levels of fingerprint identification and the second correspondence between different security levels of fingerprint identification and the feature thresholds are stored, consequently, once the current application program identifier is obtained, the feature threshold corresponding to the security level of fingerprint identification for the current application program may be obtained based on the current application program identifier and the first and second correspondences, thereby facilitating achievement of the fingerprint identification.

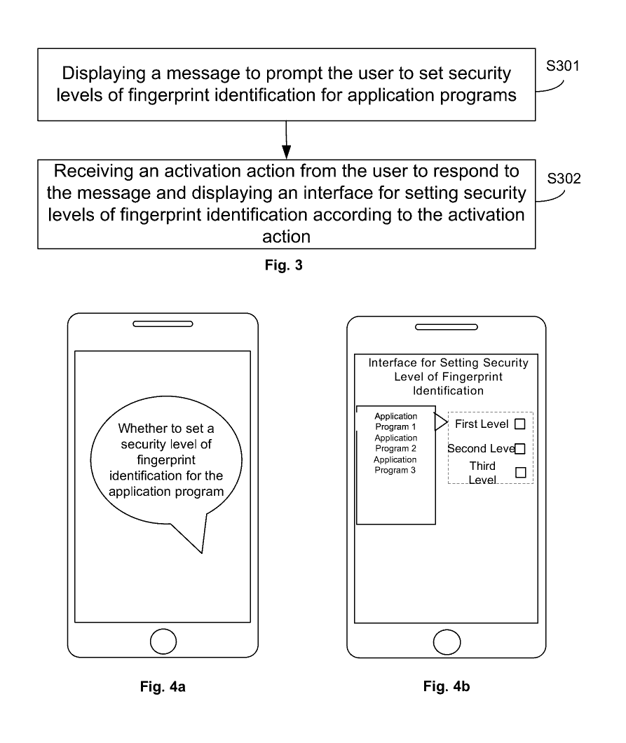

FIG. 3 is a flowchart illustrating another process for obtaining feature threshold according to an exemplary embodiment. The method for fingerprint identification may be implemented in a mobile terminal such as the apparatus 1000 in FIG. 10. For example, the method may be implemented as an application or a set of instructions stored in the non-transitory storage medium of the mobile terminal. A processor of the mobile terminal may communicate with the storage medium and execute the set of instructions to perform steps in the method. As shown in FIG. 3, prior to the step S201, the method further may include following steps.

In step S301, displaying a message to prompt the user to set security levels of fingerprint identification for application programs.

In the embodiment, the message may be displayed by the mobile terminal at intervals, for example, every other week, so as to prompt the user to set a security level of fingerprint identification for an application program. Alternatively, the message may be displayed under other trigger conditions.

As shown in FIG. 4a, the mobile phone displays a message “whether to set a security level of fingerprint identification for the application program” on its screen.

In step S302, receiving an activation action from the user to respond to the message and displaying an interface for setting security levels of fingerprint identification according to the activation action.

The activation action may be a click action on the screen of the mobile terminal. Subsequent to the example described above, the user may click a “confirm” button if he/she intends to set the security level of fingerprint identification, and may click a “cancel” button if he/she does not intend to set the security level of fingerprint identification. Assuming that the user clicks the “confirm” button, the interface for setting security levels of fingerprint identification then may be displayed on the mobile phone. As shown in FIG. 4b, the interface for setting security levels of fingerprint identification may include information on application programs and security levels for the user's selection. For example, the user selects security levels for an application program 1 and, assuming the first level is selected as the security level, checks a select box behind the first level.

According to the embodiment described above, the interface for setting security levels of fingerprint identification is displayed, such that the user is able to set security levels of fingerprint identification for different application programs directly on the interface for setting security levels of fingerprint identification, with no need for the user to access the interface for setting security levels of fingerprint identification by other means, thereby achieving simplified operation.

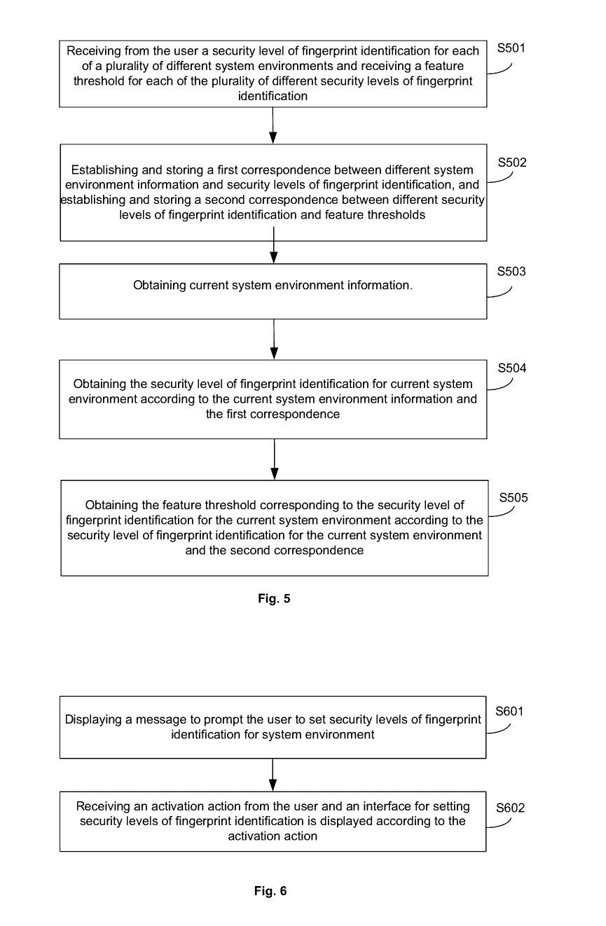

FIG. 5 is a flowchart illustrating yet another process for obtaining feature threshold according to an exemplary embodiment. The method for fingerprint identification may be implemented in a mobile terminal such as the apparatus 1000 in FIG. 10. For example, the method may be implemented as an application or a set of instructions stored in the non-transitory storage medium of the mobile terminal. A processor of the mobile terminal may communicate with the storage medium and execute the set of instructions to perform steps in the method. The method may include following steps S501-S505.

In step S501, receiving from the user a security level of fingerprint identification for each of a plurality of different system environments and receiving a feature threshold for each of the plurality of different security levels of fingerprint identification.

In order to improve the success rate of fingerprint identification, the user may set security levels of fingerprint identification for the plurality of different system environments, and set feature thresholds for the plurality of different security levels of fingerprint identification.

For example, the user may set that system environment M corresponds to the first level, system environment N corresponds to the second level. Furthermore, the user may set that a feature threshold of the first level is 0.6, and that of the second level is 0.8.

In step S502, establishing and storing a first correspondence between different system environment information and security levels of fingerprint identification, and establishing and storing a second correspondence between different security levels of fingerprint identification and feature thresholds.

In the embodiment, after the security levels of fingerprint identification for different system environment and the feature thresholds for different security levels of fingerprint identification are already set, the mobile terminal may establish and store the first correspondence between different system environment information and the security levels of fingerprint identification, as well as the second correspondence between different security levels of fingerprint identification and the feature thresholds. The two correspondences may be stored in a local storage medium of the mobile terminal, or may be stored in an account of the user in CLOUD or a remote server in communication with the mobile terminal.

In step S503, obtaining current system environment information.

In the embodiment, the current system environment information may be obtained by the fingerprint identification IC circuit of the mobile terminal.

In step S504, obtaining the security level of fingerprint identification for current system environment according to the current system environment information and the first correspondence.

In the embodiment, the mobile terminal may obtain the security level of fingerprint identification for the current system environment according to the obtained current system environment information and the stored first correspondence.

In step S505, obtaining the feature threshold corresponding to the security level of fingerprint identification for the current system environment according to the security level of fingerprint identification for the current system environment and the second correspondence.

In the embodiment, the mobile terminal may obtain the feature threshold corresponding to the security level of fingerprint identification for the current system environment according to the obtained security level of fingerprint identification and the stored second correspondence.

According to the embodiment described above, the first correspondence between different system environment information and the security levels of fingerprint identification and the second correspondence between different security levels of fingerprint identification and the feature thresholds are stored, consequently, once the current system environment information is obtained, the feature threshold corresponding to the security level of fingerprint identification for the current system environment may be obtained based on the current system environment information and the first and second correspondences, thereby facilitating achievement of the fingerprint identification.

FIG. 6 is a flowchart illustrating still another process for obtaining feature threshold according to an exemplary embodiment. The method for fingerprint identification may be implemented in a mobile terminal such as the apparatus 1000 in FIG. 10. For example, the method may be implemented as an application or a set of instructions stored in the non-transitory storage medium of the mobile terminal. A processor of the mobile terminal may communicate with the storage medium and execute the set of instructions to perform steps in the method. As shown in FIG. 6, prior to the step S501, the method in FIG. 5 may further include following steps.

In step S601, displaying a message to prompt the user to set security levels of fingerprint identification for system environment.

In the embodiment, the message may be displayed by the mobile terminal at intervals, for example, every other week, so as to prompt the user to set a security level of fingerprint identification for system environment. Alternatively, the message may be displayed under other trigger conditions.

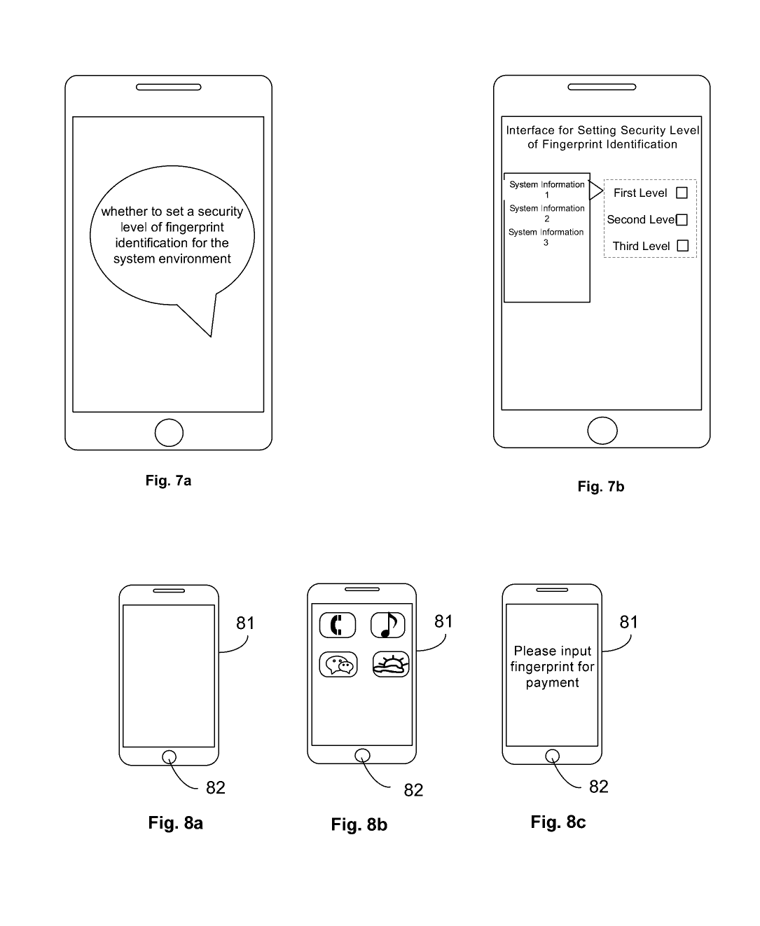

As shown in FIG. 7a, the mobile terminal displays a message “whether to set a security level of fingerprint identification for the system environment” on its screen.

In step S602, receiving an activation action from the user and an interface for setting security levels of fingerprint identification is displayed according to the activation action.

The activation action may be a click action on the screen of the mobile terminal. Subsequent to the example described above, the user may click a “confirm” button if he/she intends to set the security level of fingerprint identification, and may click a “cancel” button if he/she does not intend to set the security level of fingerprint identification. Assuming that the user clicks the “confirm” button, the interface for setting security levels of fingerprint identification then may be displayed on the mobile phone. As shown in FIG. 7b, the interface for setting security levels of fingerprint identification may include system environment information and security levels for the user's selection. For example, the user selects security levels for system environment 1 and, assuming the second level is selected as the security level, checks a select box behind the second level.

According to the embodiment described above, the interface for setting security levels of fingerprint identification is displayed, such that the user is able to set security levels of fingerprint identification for different system environment directly on the interface for setting security levels of fingerprint identification, with no need for the user to access the interface for setting security levels of fingerprint identification by other means, thereby achieving simplified operation.

The present disclosure will now be exemplarily described as follows with reference to FIGS. 8a-8c. As shown in FIG. 8a, when a user intends to use a mobile phone 81, which is in a state of screen lock, the user needs to touch with a finger on a fingerprint identification virtual button 82 of the mobile phone 81. Once the user touches the fingerprint identification virtual button 82, a fingerprint image of the user may be obtained by a fingerprint identification circuit of the mobile phone 81, and feature information may be extracted from the fingerprint image. At the same time, it is determined the operation system of the mobile phone is in the state of screen lock, thus a feature threshold corresponding to a security level of fingerprint identification for unlocking screen is obtained. Subsequently, the fingerprint identification may be performed based on the extracted feature information and the obtained feature threshold, and the mobile phone 81 may be unlocked successfully if the fingerprint identification succeeds. An interface shown after the mobile phone 81 is unlocked successfully is as illustrated in FIG. 8b. The user then may click on an application program for purchase on the mobile phone 81. Upon paying for purchased stuff, payment with finger may be adopted in order to improve security of payment, and achieved by the user pressing a finger against the fingerprint identification virtual button 82 according to a message displayed on an interface as shown in FIG. 8c. In this way, fingerprint identification may be performed for different operation information according to the embodiment with a high rate of successful identification, and repeated failure of fingerprint identification may be avoided, thereby providing convenience for the user.

Corresponding to embodiments of the method for fingerprint identification described above, there are also provided embodiments of an apparatus for fingerprint identification according to the present disclosure.

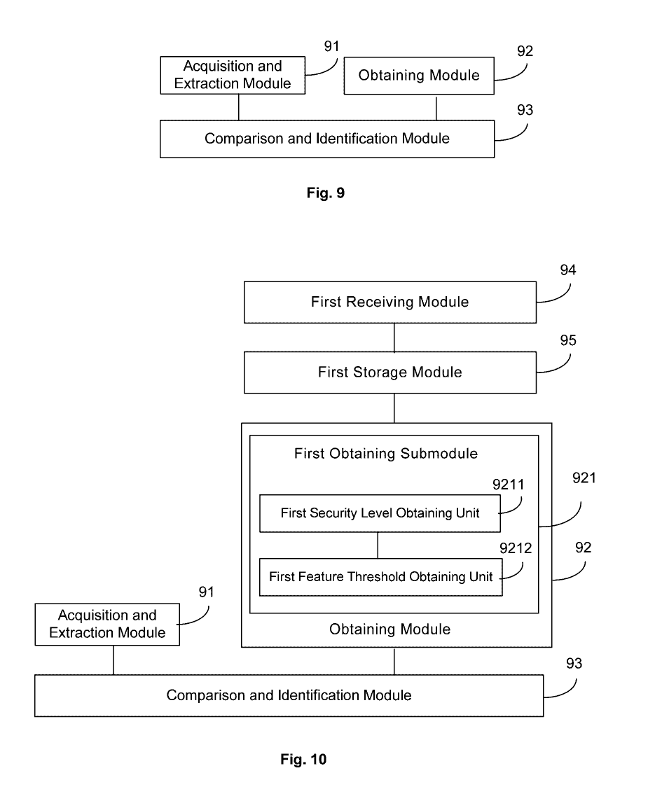

FIG. 9 is a block diagram illustrating an apparatus for fingerprint identification according to an exemplary embodiment. The apparatus may be a mobile terminal such as the apparatus 1000 in FIG. 10. As shown in FIG. 9, the apparatus for fingerprint identification may include an acquisition and extraction module 91, an obtaining module 92 and an identification module 93.

The acquisition and extraction module 91 may be configured to obtain a fingerprint image and extract feature information of the fingerprint image.

The obtaining module 92 may be configured to obtain current mobile terminal operation information and obtain a feature threshold corresponding to a security level of fingerprint identification based on the current mobile terminal operation information.

The comparison and identification module 93 may be configured to compare the feature information extracted by the acquisition and extraction module 91 with verification feature information stored in advance, determine the fingerprint identification succeeds if a comparison result reaches the feature threshold obtained by the obtaining module 92, and determine the fingerprint identification fails if the comparison result does not reach the feature threshold.

A process of fingerprint identification for the apparatus shown in FIG. 9 may refer to corresponding parts in the embodiment of method shown in FIG. 1 and will not be elaborated herein.

According to the embodiments of the apparatus for fingerprint identification described above, the current mobile terminal operation information is obtained and the feature threshold corresponding to the security level of fingerprint identification is obtained based thereon, the fingerprint identification is then performed according to the extracted feature information and the corresponding feature threshold, thus a process of fingerprint identification may be finished based on the feature threshold corresponding to the security level of fingerprint identification, thereby improving a rate of successful fingerprint identification.

FIG. 10 is a block diagram illustrating another apparatus for fingerprint identification according to an exemplary embodiment. The apparatus may be a mobile terminal such as the apparatus 1000 in FIG. 10. As shown in FIG. 10, the obtaining module 92, based on the embodiment as shown in FIG. 9, further may include a first obtaining submodule 921.

The first obtaining submodule 921 may be configured to obtain a current application program identifier and obtain the feature threshold corresponding to the security level of fingerprint identification for a current application program based on the current application program identifier.

In addition, the apparatus may also include a first receiving module 94 and a first storage module 95.

The first receiving module 94 may be configured to, before the first obtaining submodule 021 obtains the feature threshold corresponding to the security level of fingerprint identification for the current application program based on the current application program identifier, receive from a user the security levels of fingerprint identification set for different application programs and the feature thresholds set for different security levels of fingerprint identification.

The first storage module 95 may be configured to store a first correspondence between different application program identifiers and the security levels of fingerprint identification received by the first receiving module 94, and store a second correspondence between different security levels of fingerprint identification and the feature thresholds.

In an embodiment, the first obtaining sub-module 921 may further include a first security level obtaining unit 9211 and a first feature threshold obtaining unit 9212.

The first security level obtaining unit 9211 may be configured to obtain the security level of fingerprint identification for the current application program according to the current application program identifier and the first correspondence.

The first feature threshold obtaining unit 9212 may be configured to obtain the feature threshold corresponding to the security level of fingerprint identification for the current application program according to the security level of fingerprint identification for the current application program obtained by the first security level obtaining unit 9211 and the second correspondence.

A process of fingerprint identification for the apparatus shown in FIG. 10 may refer to corresponding parts in the embodiment of method shown in FIG. 2 and will not be elaborated herein.

According to the embodiment described above, the first correspondence between different application program identifiers and the security levels of fingerprint identification and the second correspondence between different security levels of fingerprint identification and the feature thresholds are stored, consequently, once the current application program identifier is obtained, the feature threshold corresponding to the security level of fingerprint identification for the current application program may be obtained based on the current application program identifier and the first and second correspondences, thereby facilitating achievement of the fingerprint identification.

FIG. 11 is a block diagram illustrating another apparatus for fingerprint identification according to an exemplary embodiment. The apparatus may be a mobile terminal such as the apparatus 1000 in FIG. 10. As shown in FIG. 11, the apparatus, based on the embodiment as shown in FIG. 10, further may include a first message display module 96 and a first receiving and display module 97.

The first message display module 96 may be configured to, before the first receiving module 94 receives from the user the security levels of fingerprint identification set for different application programs and the feature thresholds set for different security levels of fingerprint identification, display a message to prompt the user to set a security level of fingerprint identification for an application program.

The first receiving and display module 97 may be configured to receive from the user an activation action and display an interface for setting security levels of fingerprint identification according to the activation action.

A process of fingerprint identification for the apparatus shown in FIG. 11 may refer to corresponding parts in the embodiment of method shown in FIG. 3 and will not be elaborated herein.

According to the embodiment described above, the interface for setting security levels of fingerprint identification is displayed, such that the user is able to set security levels of fingerprint identification for different application programs directly on the interface for setting security levels of fingerprint identification, with no need for the user to access the interface for setting security levels of fingerprint identification by other means, thereby achieving simplified operation.

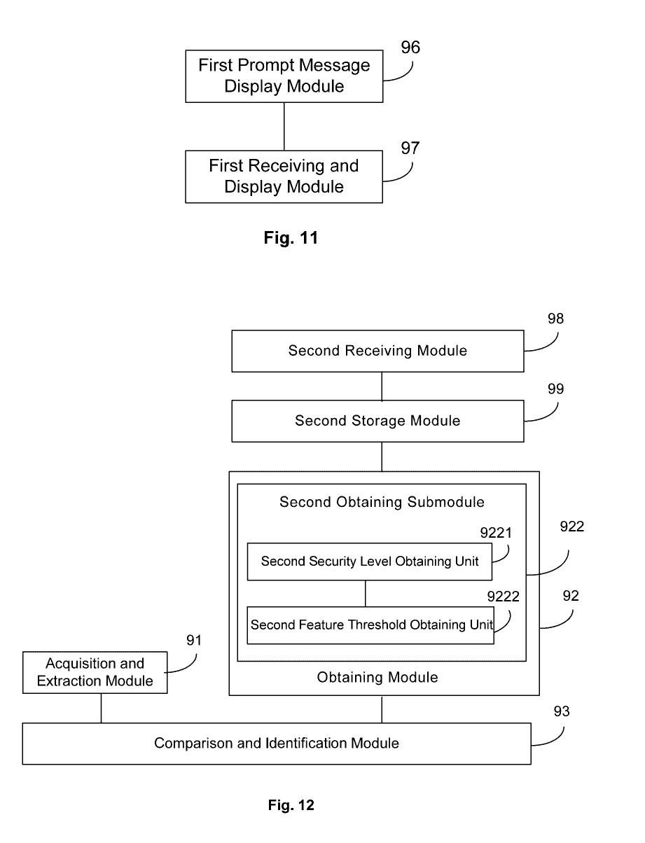

FIG. 12 is a block diagram illustrating another apparatus for fingerprint identification according to an exemplary embodiment. The apparatus may be a mobile terminal such as the apparatus 1000 in FIG. 10. As shown in FIG. 12, the obtaining module 92, based on the embodiment as shown in FIG. 9, further may include a second obtaining submodule 922.

The second obtaining submodule 922 may be configured to obtain current system environment information and obtain the feature threshold corresponding to the security level of fingerprint identification for current system environment based on the current system environment information.

In addition, the apparatus may also include a second receiving module 98 and a second storage module 99.

The second receiving module 98 may be configured to, before the second obtaining submodule obtains the feature threshold corresponding to the security level of fingerprint identification for the current system environment based on the current system environment information, receive from a user security levels of fingerprint identification set for different system environment and feature thresholds set for different security levels of fingerprint identification.

The second storage module 99 may be configured to store a first correspondence between different system environment information and the security levels of fingerprint identification received by the second receiving module 98, and store a second correspondence between the different security levels of fingerprint identification and the feature thresholds.

In an embodiment, the second obtaining submodule 922 may further include a second security level obtaining unit 9221 and a second feature threshold obtaining unit 9222.

The second security level obtaining unit 9221 may be configured to obtain the security level of fingerprint identification for the current system environment according to the current system environment information and the first correspondence.

The second feature threshold obtaining unit 9222 may be configured to obtain the feature threshold corresponding to the security level of fingerprint identification for the current system environment according to the security level of fingerprint identification for the current system environment obtained by the second security level obtaining unit 9221 and the second correspondence.

A process of fingerprint identification for the apparatus shown in FIG. 12 may refer to corresponding parts in the embodiment of method shown in FIG. 5 and will not be elaborated herein.

According to the embodiment described above, the first correspondence between different system environment information and the security levels of fingerprint identification and the second correspondence between different security levels of fingerprint identification and the feature thresholds are stored, consequently, once the current system environment information is obtained, the feature threshold corresponding to the security level of fingerprint identification for the current system environment may be obtained based on the current system environment information and the first and second correspondences, thereby facilitating achievement of the fingerprint identification.

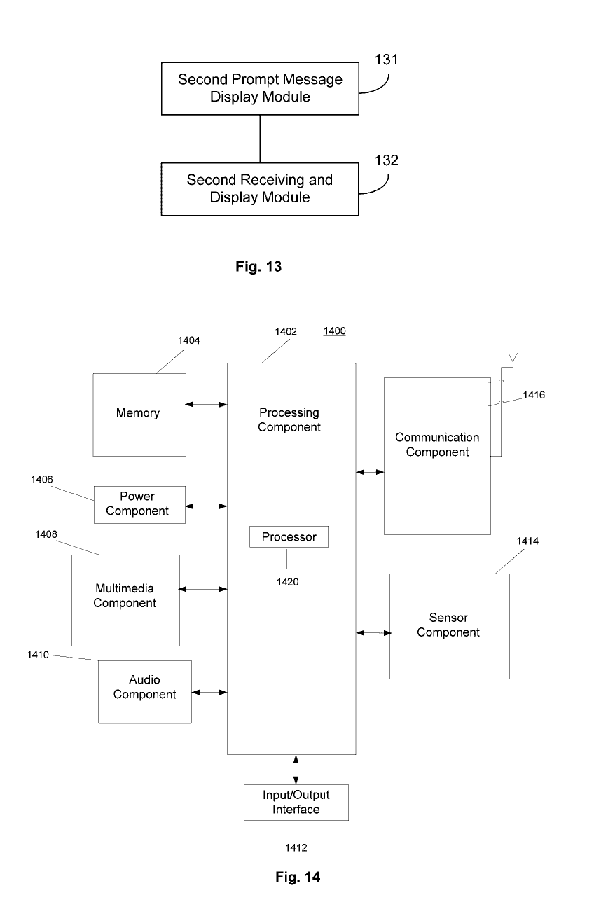

FIG. 13 is a block diagram illustrating another apparatus for fingerprint identification according to an exemplary embodiment. The apparatus may be a mobile terminal such as the apparatus 1000 in FIG. 10. As shown in FIG. 13, the apparatus, based on the embodiment as shown in FIG. 12, further may include a second message display module 131 and a second receiving and display module 132.

The second message display module 131 may be configured to, before receiving from a user the security levels of fingerprint identification set for different system environment and the feature thresholds set for different security levels of fingerprint identification, display a message to prompt the user to set a security level of fingerprint identification for system environment.

The second receiving and display module 132 may be configured to receive from the user an activation action and display an interface for setting security levels of fingerprint identification according to the activation action.

A process of fingerprint identification for the apparatus shown in FIG. 13 may refer to corresponding parts in the embodiment of method shown in FIG. 6 and will not be elaborated herein.

According to the embodiment described above, the interface for setting security levels of fingerprint identification is displayed, such that the user is able to set security levels of fingerprint identification for different system environment directly on the interface for setting security levels of fingerprint identification, with no need for the user to access the interface for setting security levels of fingerprint identification by other means, thereby achieving simplified operation.

With respect to the apparatus in the above embodiments, the specific manners for performing operations for individual modules and submodules therein have been described in detail in the embodiments regarding the methods, which will not be elaborated herein.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

1. An electronic device, comprising:
a processor-readable storage medium comprising a set of instructions for image identification; and
a processor in communication with the storage medium, wherein the processor is configured to:
obtain a target image for authorization of a target event though image identification;
obtain a target security requirement associated with the target event from a plurality of levels of security requirements;
determine whether the target image is successfully identified based on the target security requirement; and
operate the target event when the target image is successfully identified.

2. The electronic device of claim 1, further comprising:
a fingerprint identification sensor in communication with the processor,
wherein the processor is further configured to cause the fingerprint identification sensor to scan a fingerprint of a user as the target image.

3. The electronic device of claim 1, wherein the target event comprises at least one of running an application program or running a system operation.

4. The electronic device of claim 1, wherein to obtain the security requirement associated with the target event, the processor is further configured to:
obtain a target security level associated with the target event from a plurality of security levels; and
obtain a target feature threshold associated with the target security level.

5. The electronic device of claim 4, wherein the target security level associated with the target event is predetermined by a user of the mobile terminal.

6. The electronic device of claim 4, wherein the target feature threshold is predetermined by the user of the mobile terminal.

7. The electronic device of claim 4, wherein the processor is further configured to:
extract feature information from the target image,
wherein to determine whether the target image is successfully identified, the processor is further configured to:
determine a similarity value between the feature information with pre-stored verification feature information;
determine the target image is successfully identified when the similarity value is greater than the feature threshold; and
determine the target image is not identified when the similarity value is less than the feature threshold.

8. A method for image identification, comprising:
obtaining, by a mobile terminal, a target image for authorization of a target event though image identification;
selecting, by the mobile terminal, a target security requirement associated with the target event from a plurality of levels of security requirements;
determining, by the mobile terminal, whether the target image is successfully identified based on the selected target security requirement; and
operating, by the mobile terminal, the target event when the target image is successfully identified.

9. The method of claim 8, further comprising:
directing, by the mobile terminal, a fingerprint identification sensor to scan a fingerprint of a user as the target image.

10. The method of claim 8, wherein the target event comprises at least one of running an application program or running a system operation.

11. The method of claim 8, wherein selecting the target security requirement comprises:
obtaining a target security level associated with the target event from a plurality of security levels; and
obtaining a target feature threshold associated with the target security level.

12. The method of claim 11, wherein the target security level associated with the target event is predetermined by a user of the mobile terminal.

13. The method of claim 11, wherein the target feature threshold is predetermined by the user of the mobile terminal.

14. The method of claim 11, further comprising:
extracting, by the mobile terminal, feature information from the target image,
wherein the determining of whether the target image is successfully identified comprises:
determining a similarity value between the feature information with pre-stored verification feature information;
determining the target image is successfully identified when the similarity value is greater than the target feature threshold; and
determining the target image is not identified when the similarity value is less than the target feature threshold.

15. A processor-readable non-transitory storage medium, comprising a set of instruction for image identification, wherein when executed by a processor the set of instruction directs the processor to:
obtain a target image for authorization of a target event though image identification;
obtain a target security requirement associated with the target event from a plurality of levels of security requirements;
determine whether the target image is successfully identified based on the target security requirement; and
operate the target event when the target image is successfully identified.

16. The storage medium of claim 15, wherein the set of instructions further directs the processor to:
direct a fingerprint identification sensor to scan a fingerprint of a user as the target image.

17. The storage medium of claim 15, wherein to obtain the security requirement of image identification the set of instructions further directs the processor to:
select a target security level associated with the target event from a plurality of security levels; and
obtain a target feature threshold associated with the target security level.

18. The storage medium of claim 17, wherein the target security level associated with the target event is predetermined by a user of the mobile terminal

19. The storage medium of claim 17, wherein the target feature threshold is predetermined by the user of the mobile terminal.

20. The storage medium of claim 17, wherein the set of instructions further directs the processor to:
extract, by the mobile terminal, feature information from the target image,
wherein to determine whether the target image is successfully identified the set of instructions further directs the processor to:
determine a similarity value between the feature information with pre-stored verification feature information;
determine the target image is successfully identified when the similarity value is greater than the feature threshold; and
determine the target image is not identified when the similarity value is less than the feature threshold.
